(19) United States
(12) Patent Application Publication
(10) Pub. No.: US 2011/0248944 A1
(43) Pub. Date: Oct. 13, 2011

(54) TOUCH DISPLAY PANEL

(75) Inventors: Chin-Chang Liu, Taichung County (TW); Kuo-Chang Su, Tainan County (TW)

(73) Assignee: WINTEK CORPORATION, Taichung City (TW)

(21) Appl. No.: 13/082,412

(22) Filed: Apr. 8, 2011

(30) Foreign Application Priority Data
Apr. 9, 2010 (TW) 99111110

(51) Int. Cl. G06F 3/041

(52) U.S. Cl. 345/173

(57) ABSTRACT

A touch display panel having a display area and an operation area is provided. The touch display panel includes a first substrate, a first transparent electrode layer, a dielectric layer, a second electrode layer, a display medium, an active array device, and a second substrate sequentially disposed. The first substrate and the second substrate are disposed opposite to each other. The first transparent electrode layer includes a first display area pattern located in the display area and a first operation area pattern located in the operation area. The second transparent electrode layer includes a second display area pattern located in the display area and a second operation area pattern located in the operation area. The second display area pattern has a plurality of openings so as to expose a portion of the first display area pattern.

### CROSS-REFERENCE TO RELATED APPLICATION

This application claims the priority benefit of Taiwan application serial no. 99111110, filed Apr. 9, 2010. The entirety of the above-mentioned patent application is hereby incorporated by reference herein and made a part of this specification.

### BACKGROUND OF THE INVENTION

1. Field of the Invention

The invention generally relates to a touch display panel, and more particularly, to a touch display panel having independent operation area.

2. Description of Related Art

Input devices of the IT products have been changed from conventional keyboards and mice to touch panels so as to comply with requirements for convenience, miniaturization, and being user-friendly. At present, the touch panels can be generally classified into resistive, capacitive, infrared, and ultrasonic touch panels, wherein the resistive touch panels and the capacitive touch panels are most common.

The integration of the touch panel with the display panel provides electronic products both functions of image display and touch operation, and thus attracts great attention. In conventional fabrication process, the touch panel and the display panel are fabricated separately, and an adhering process is then performed to integrate the touch panel and the display panel. However, the separate fabrications of the touch panel and the display panel increase fabrication costs and the adhering process complicates the fabrication process of electronic products. Thus, techniques for simultaneously fabricating display panel and touch panel in the same fabrication step have been proposed.

### SUMMARY OF THE INVENTION

The invention is directed to a touch display panel without additional process of touch sensing device.

The invention is directed to a touch display panel, wherein the display has a display area and an operation area located beside the display area. Specifically, the touch display panel includes a first substrate, a second substrate, a display medium, a first transparent electrode layer, a second transparent electrode layer, a dielectric layer, and an active array device. The second substrate and the first substrate are disposed opposite to each other. The display medium is sandwiched between the first substrate and the second substrate and corresponding to the display area. The first transparent electrode layer is disposed on the first substrate. The first transparent electrode layer includes a first display area pattern and a first operation area pattern, wherein the first display area pattern is located in the display area and the first operation area pattern is located in the operation area. The dielectric layer is disposed on the first transparent electrode layer. The second transparent electrode layer is disposed on the dielectric layer and includes a second display area pattern and a second operation area pattern. The second display area pattern is located in the display area and the second operation area pattern is located in the operation area, wherein the second display area pattern has a plurality of openings so as to expose a portion of the first display area pattern. The active array device is disposed on the second substrate.

Accordingly, the display panel of the present invention has both functions of image display and touch operation without additional process of touch sensing device. In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B illustrate schematic top views of two displays with touch panels of the invention.

FIG. 2A is a schematic cross-sectional view of a touch display panel according to a first embodiment of the invention.

FIG. 2B is a schematic top view showing a touch device.

FIG. 3 is a schematic cross-sectional view of a touch display panel according to a second embodiment of the invention.

FIG. 4A is a schematic cross-sectional view of a touch display panel according to a third embodiment of the invention.

FIG. 4B is a schematic top view showing a touch device in FIG. 4A.

FIG. 5A illustrates a schematic cross-sectional view of a touch display panel according to a fourth embodiment of the invention.

FIG. 5B is a schematic top view depicting a touch device shown in FIG. 5A.

FIG. 6A illustrates a schematic cross-sectional view of a touch display panel according to a fifth embodiment of the invention.

FIG. 6B is a schematic top view of a pixel electrode of the touch display panel shown in FIG. 6A.

### DESCRIPTION OF EMBODIMENTS

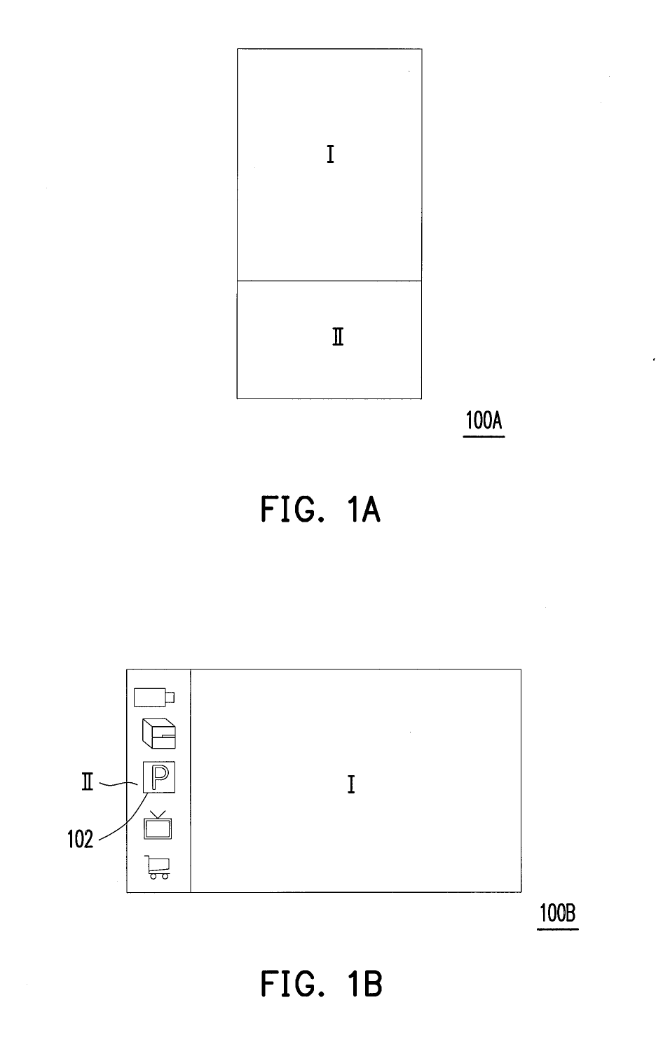

FIGS. 1A and 1B illustrate schematic top views of two touch display panels of the invention. Referring to FIGS. 1A and 1B simultaneously, the touch display panel 100A and the touch display panel 100B respectively has a display area I and an operation area II. The display area I is located adjacent to the operation area II. The touch display panel 100A and the touch display panel 100B are both display panels having touch operation function. The difference between the touch display panel 100A and the touch display panel 100B is that the surface of the touch display panel 100B is printed with a plurality of icons 102, so that the user can readily click on the icon 102 to execute the desired function.

The touch display panel 100A and the touch display panel 100B include touch device (not shown) and display device (not shown) to provide both functions of touch operation and image display. In the present embodiment, the display device (not shown) is disposed in the display area I and the touch device (not shown) is disposed in the operation area II. In order to save fabrication process, the touch device (not shown) can be fabricated without additional process of touch device to provide both functions of image display and touch operation.

In order to illustrate this concept, the following embodiments are provided to describe relationships between the touch device (not shown) and the display device (not shown). It should be noted that features depicted in the following embodiments are applicable in the touch display panel 100A and the touch display panel 100B. However, the design of the touch display panel 100A and the touch display panel 100B is not limited thereto.

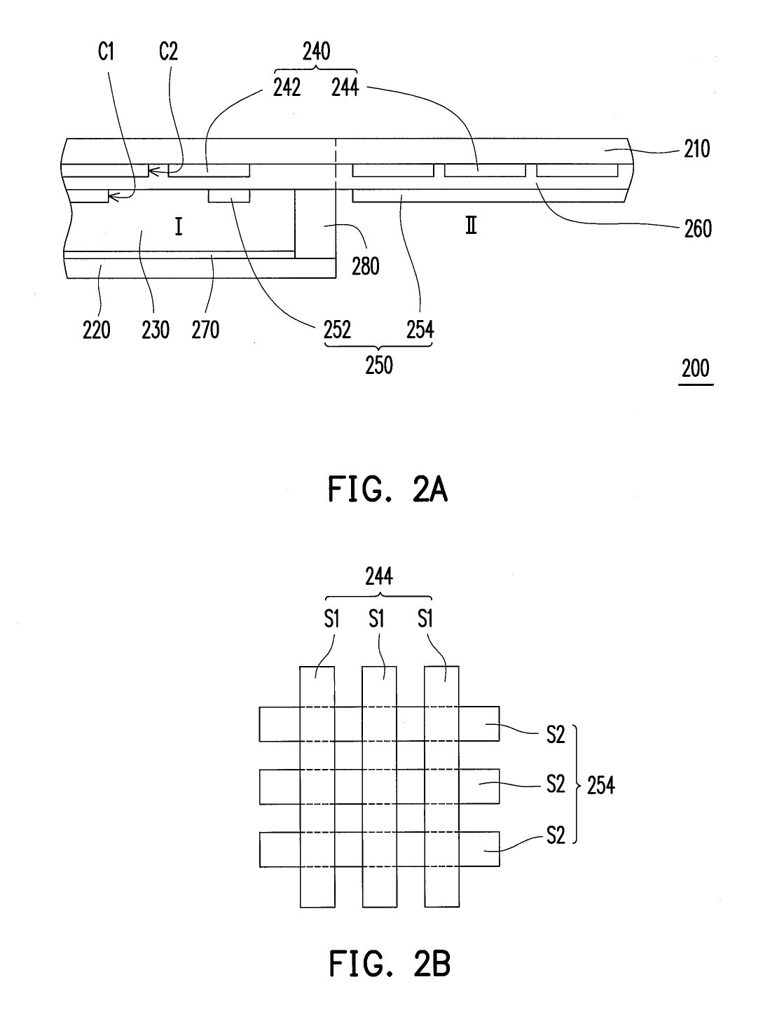

FIG. 2A is a schematic cross-sectional view of a touch display panel according to a first embodiment of the invention. Referring to FIG. 2A, a touch display panel 200 includes a display area I for displaying an image and an operation area II for performing a touch operation. The touch display panel 200 includes a first substrate 210, a second substrate 220, a display medium 230, a first transparent electrode layer 240, a second transparent electrode layer 250, a dielectric layer 260, an active array device 270, and a sealant 280.

The second substrate 220 and the first substrate 210 are disposed opposite to each other. The display medium 230 is sandwiched between the first substrate 210 and the second substrate 220. The active array device 270 is disposed on the second substrate 220. The first transparent electrode layer 240 is disposed on the first substrate 210. Moreover, the dielectric layer 260 is disposed on the first transparent electrode layer 240. The second transparent electrode layer 250 is disposed on the dielectric layer 260. The sealant 280 is disposed between the first substrate 210 and the second substrate 220 and located at a boundary between the display area I and the operation area II.

Additionally, in order to present colorful display effect, the dielectric layer 260 can be a color filter layer. In other embodiments, the dielectric layer 260 is a transparent dielectric layer, and the color filter layer is disposed between the first substrate 210 and the first transparent electrode 240 or integrated in the active array device 270. In the present embodiment, the active array device 270 includes a plurality of active devices (not shown) arranged in an array and a plurality of pixel electrodes (not shown) electrically connected thereto. Further, the display medium 230 is liquid crystal material of vertical alignment type.

Notably, when the display medium 230 is liquid crystal material of vertical alignment type, the first transparent electrode layer 240 and the second transparent electrode layer 250 adopt the design of a double-layered common electrode to provide the wide-viewing angle effect.

In details, in the present embodiment, the first transparent electrode layer 240 located in the display area I is defined as a first display area pattern 242, and the second transparent electrode layer 250 located in the display area I is defined as a second display area pattern 252. The first display area pattern 242 is deemed as a first common electrode and the second display area pattern 252 is deemed as a second common electrode. The second display area pattern 252 has a plurality of openings C1 for exposing a portion of the first display area pattern 242. The first display area pattern 242 also has a plurality of sub-openings C2, where the sub-openings C2 are smaller than the openings C1 so as to be exposed by the openings C1. Accordingly, an electric field formed between the pixel electrodes (not shown) and the first display area pattern 242 is different from that formed between the pixel electrodes (not shown) and the second display area pattern 252 when the touch display panel 200 is operated. Therefore, the display medium 230 adopts a multi-domain vertical alignment arrangement to represent a wide-viewing angle display effect.

Since two transparent electrode layers are disposed on the first substrate 210 of the touch display panel 200 and conventional touch devices are mostly constituted by the two-layered electrode layer, the first transparent electrode layer 240 and the second transparent electrode layer 250 are not only used for fabricating the common electrode for display, but also fabricating the touch device. Hence, the first transparent electrode layer 240 located in the operation area II is defined as a first operation area pattern 244, and the second transparent electrode layer 250 located in the operation area II is defined as a second operation area pattern 254.

The first operation area pattern 244 and the second operation area pattern 254 constitute the touch device in the present embodiment. The touch device can be disposed in an arrangement in FIG. 2B illustrating a schematic top view of a touch device. Referring to FIGS. 2A and 2B simultaneously, the first operation area pattern 244 includes a plurality of first touch electrode stripes S1 parallel to one another. The second operation area pattern 254 includes a plurality of second touch electrode stripes S2 parallel to one another. An extending direction of each first touch electrode stripe S1 and an extending direction of each second touch electrode stripe S2 intersect with each other.

It should be noted that the first display area pattern 242 and the first operation area pattern 244 are fabricated from the first transparent electrode layer 240. Similarly, the second display area pattern 252 and the second operation area pattern 254 are fabricated from the second transparent electrode layer 250. Thus, the display device and the touch device can be fabricated simultaneously without additional fabrication steps to simplify the manufacturing process.

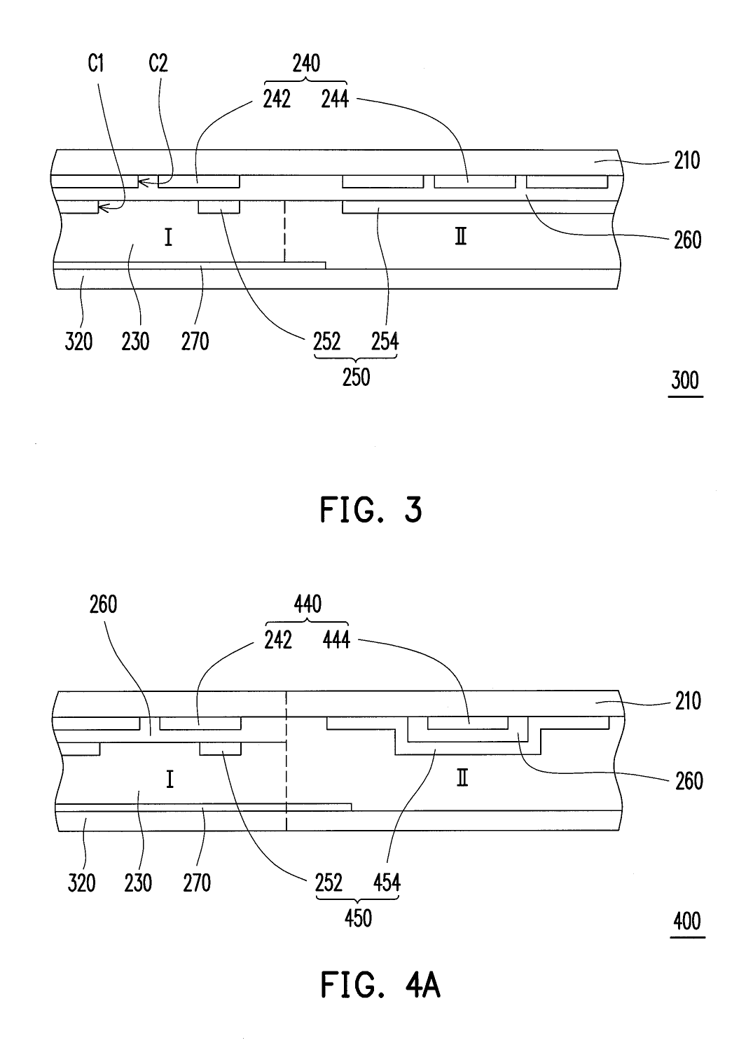

In the first embodiment shown in FIG. 2, an edge of the second substrate 220 is aligned with an edge of the display area I. However, the touch display panel 300 of a second embodiment shown in FIG. 3 is has a larger second substrate 320 than the second substrate 220 of the first embodiment and has a display area I and an operation area II. In other words, the second substrate 320 can be substantially as large as the first substrate 210. It should be noted that in the design of the touch display panel 300, other than a dimension of the second substrate 320, the remaining devices are all identical to those in the touch display panel 200, so there is no more detailed description for the same devices herein.

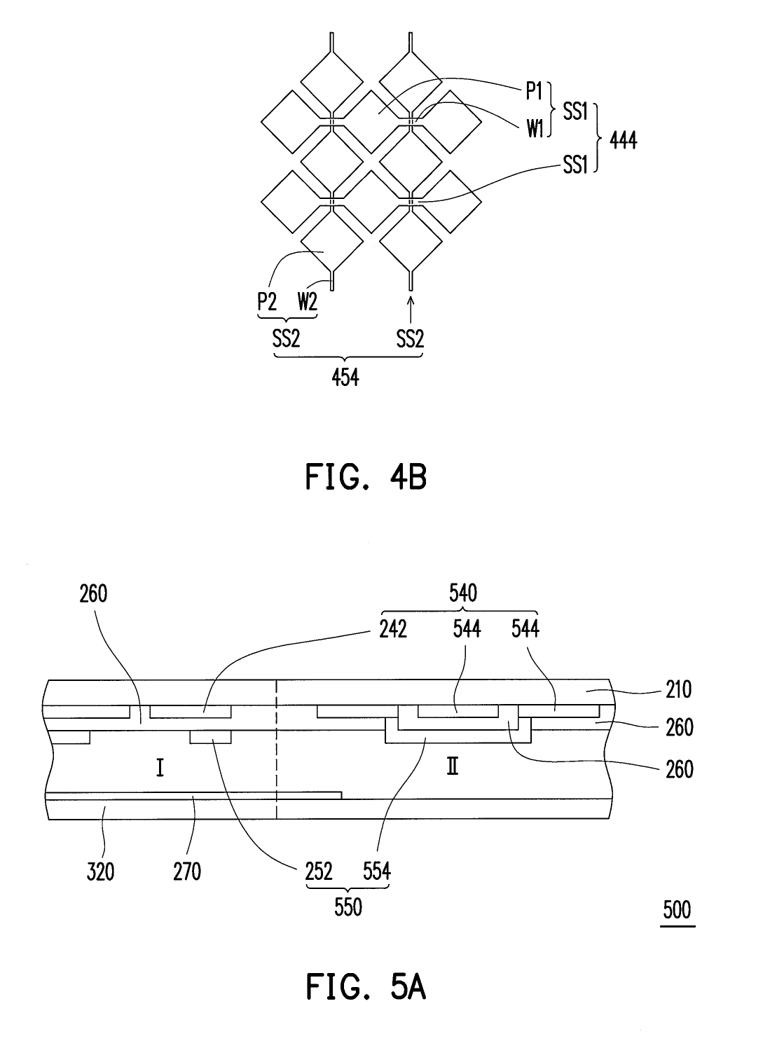

FIG. 4A shows a schematic cross-sectional view of a touch display panel according to a third embodiment of the invention, and FIG. 4B is a schematic top view of a touch device shown in FIG. 4A. Referring to FIGS. 4A and 4B simultaneously, a touch display panel 400 has a display area I and an operation area II located beside the display area I. The touch display panel 400 includes a first substrate 210, a second substrate 320, a display medium 230, a first transparent electrode layer 440, a second transparent electrode layer 450, a dielectric layer 260, and an active array device 270. The touch display panel 400 is different from the foregoing embodiments mainly in the pattern design of the first transparent electrode layer 440 and the second transparent electrode layer 450.

In details, the first transparent electrode layer 440 includes a first display area pattern 242 located in the display area I and a first operation area pattern 444 located in the operation area II. The second transparent electrode layer 450 includes a second display area pattern 252 located in the display area I and a second operation area pattern 454 located in the operation area II. Referring to FIGS. 4A and 4B simultaneously, the first operation area pattern 444 has a plurality of first sensing series SS1 parallel to one another and the second operation area pattern 454 has a plurality of second sensing series SS2 parallel to one another, wherein an extending direction of the first sensing series SS1 and an extending direction of the second sensing series SS2 intersect with each other.

In addition, each first sensing series SS1 includes a plurality of first sensing pads P1 and a plurality of first connecting portions W1 serially connecting the first sensing pads P1. Similarly, each second sensing series SS2 includes a plurality of second sensing pads P2 and a plurality of second connecting portions W2 serially connecting the second sensing pads P2. Furthermore, the dielectric layer 260 is located between the first connecting portions W1 and the corresponding second connecting portions W2 in the operation area II to prevent short circuit between the first sensing series SS1 and the second sensing series SS2.

Notably, when the dielectric layer 260 is a color filter layer, the dielectric layer 260 can be constituted by a plurality of color filter patterns and a black matrix made of chromium and the like. Therefore, in order to increase the signal transmission efficiency of the touch device, the chromium black matrix can be placed at the first connecting portions W1 or at the second connecting portions W2, and the color filter patterns or non-conductive materials are further disposed between the first connecting portion W1 and the corresponding second connecting portion W2.

The first sensing pads P1 and the second sensing pads P2 are formed from the first transparent electrode layer 440 and the second transparent electrode layer 450 respectively. Nevertheless, the dielectric layer 260 exposes a portion of the first substrate 210 in the operation area II, so that the first sensing pads P1 are co-planar with the second sensing pads P2.

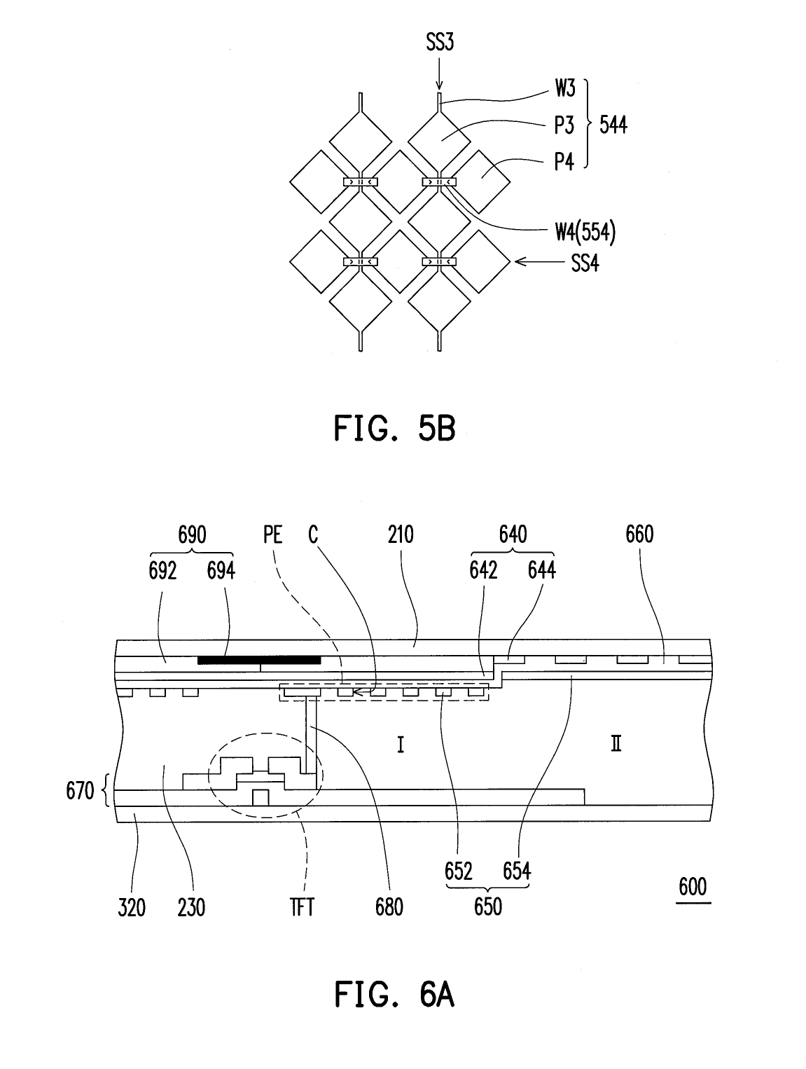

FIG. 5A shows a schematic cross-sectional view of a touch display panel according to a fourth embodiment of the invention, and FIG. 5B is a schematic top view of a touch device shown in FIG. 5A. Referring to FIGS. 5A and 5B simultaneously, a touch display panel 500 also has a display area I and an operation area II located beside the display area I. The touch display panel 500 and the touch display panel 400 are mainly different in the design of the sensing series, so there is no more detailed description for the same devices herein.

In the present embodiment, a first operation area pattern 544 of a first transparent electrode layer 540 includes a plurality of first sensing pads P3, a plurality of second sensing pads P4, and a plurality of first connecting portions W3. The first sensing pads P3 and the second sensing pads P4 are arranged in a cross arrangement, and the first connecting portions W3 are configured for serially connecting the first sensing pads P3 to constitute a plurality of first sensing series SS3. A second operation area pattern 554 of a second transparent electrode layer 550 includes a plurality of second connecting portions W4. The second connecting portions W4 are configured for serially connecting the second sensing pads P4 to constitute a plurality of second sensing series SS4, wherein the dielectric layer 260 is located between the first connection portions W3 and the second connecting portions W4.

The sensing pads P3 and P4 are constituted by the first transparent conductive layer 540, and the second connecting portions W4 are constituted by the second transparent conductive layer 550. The sensing pads P3 and P4 can be fabricated in the same fabrication step by adopting this design. Thus, the precise position between the sensing pads P3 and P4 can be obtained by fabricating the sensing pads P3 and P4 in the same step such that excellent touch sensing sensitivity is maintained.

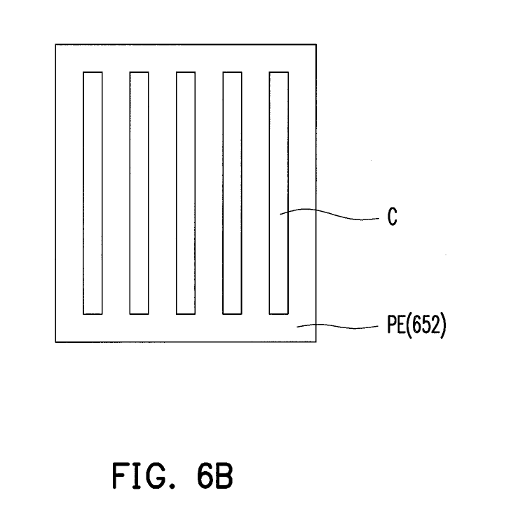

Besides, the display device can be another embodiment. FIG. 6A illustrates a schematic cross-sectional view of a touch display panel according to a fifth embodiment of the invention. Referring to FIG. 6A, a touch display panel 600 with a display area I and an operation area II has a first substrate 210, a second substrate 320, a display medium 230, a first transparent electrode layer 640, a second transparent electrode layer 650, a dielectric layer 660, and an active array device 670.

The touch display panel 600 further includes a color filter layer 690 disposed between the first substrate 210 and a first display area pattern 642. In other words, other than the dielectric layer 660, the color filter layer 690 can be further disposed to represent colorful display quality. The color filter layer 690 is constituted by a plurality of color filter patterns 692 and a black matrix 694.

Similar to the embodiments aforementioned, two transparent electrode layers are disposed on the first substrate 210 in the present embodiment. The first transparent electrode layer 640 includes a first display area pattern 642 and a first operation area pattern 644. The second transparent electrode layer 650 includes a second display area pattern 652 and a second operation area pattern 654. It should be noted that the first operation area pattern 642 in the operation area II is substantially identical to the first operation area pattern 242 in the first embodiment, and the second operation area pattern 652 is also substantially identical to the second operation area pattern 252. In other words, the present embodiment and the first embodiment are different mainly in the devices in the display area I.

Specifically, FIG. 6B illustrates a schematic top view of a pixel electrode of the touch display panel shown in FIG. 6A. Referring to FIG. 6A and FIG. 6B simultaneously, the first display area pattern 642 is substantially a complete common electrode and the second display area pattern 652 is a plurality of pixel electrodes PE with openings C to expose the common electrode (that is, the first display area pattern 642). In addition, the active array device 670 includes a plurality of active devices TFT (only one is shown in the figure for illustration) arranged in an array, and each active device TFT is electrically connected to one of the pixel electrodes PE.

The touch display panel 600 further includes a plurality of conductors 680 for the electrical connection between the active devices TFT and the pixel electrodes PE, wherein the conductors 680 are disposed between the first substrate 210 and the second substrate 220. Additionally, the conductors 680 are conductive spacers constituted by pillar-shaped spacers covered by a conductive layer. Alternatively, the conductive spacers are other conductive spacers adopted in the field.

When the touch display panel 600 displays, a common voltage is inputted into the first display area pattern 642 and the active device TFT inputs a display voltage into the pixel electrode PE, wherein the common voltage is different from the display voltage. The openings C in the pixel electrode PE expose the first display area pattern 642 to provide an electric field such that the display medium 230 is affected by the electric field in a specific arrangement.

In other words, the touch display panel 600 is a fringe field switch (FFS) display panel. One of the features thereof is that the pixel electrode PE and the common electrode (the first display area pattern 642) are disposed on the same substrate (the first substrate 210). Since two transparent electrode layers are originally fabricated on the first substrate 210, the touch device can be disposed in the operation area II by using these transparent electrode layers. In other words, the touch display panel of the present embodiment includes functions of touch operation and image display without additional fabrication steps.

Obviously, the touch device in the operation area II can also be the sensing series aforementioned in the foregoing embodiments. That is, the devices in the display area I of the present embodiment can also be applied in the displays with the touch panels illustrated in the third embodiment and the fourth embodiment.

In summary, in the touch display panel of the invention, two transparent electrode layers are disposed on one substrate. Thus, the touch device can be constituted simply by extending the two original transparent electrode layers outside of the display area. In other words, the display panel has the functions of touch operation and image display without adding any fabrication step. Hence, the design concept of the invention facilitates in simplifying the fabrication of display panel and increasing functions of display panel.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display panel, having a display area and an operation area located beside the display area, the touch display panel comprising:
a first substrate;
a second substrate, disposed opposite to the first substrate;
a display medium, disposed in the display area and sandwiched between the first substrate and the second substrate;
a first transparent electrode layer, disposed on the first substrate and comprising a first display area pattern located in the display area and a first operation area pattern located in the operation area;
a dielectric layer, disposed on the first transparent electrode layer;
a second transparent electrode layer, disposed on the dielectric layer and comprising a second display area pattern located in the display area and a second operation area pattern located in the operation area; and
an active array device, disposed on the second substrate.

2. The touch display panel as claimed in claim 1, wherein the dielectric layer is a color filter layer.

3. The touch display panel as claimed in claim 1, wherein the first operation area pattern comprises a plurality of first touch electrode stripes parallel to one another, and the second operation area pattern comprises a plurality of second touch electrode stripes parallel to one another, wherein an extending direction of each first touch electrode stripe and an extending direction of each second touch electrode stripe intersect each other.

4. The touch display panel as claimed in claim 1, wherein the first operation area pattern comprises a plurality of first sensing series parallel to one another, and the second operation area pattern comprises a plurality of second sensing series parallel to one another, wherein an extending direction of each first sensing series and an extending direction of each second sensing series intersect each other.

5. The touch display panel as claimed in claim 4, wherein each first sensing series comprises a plurality of first sensing pads and a plurality of first connecting portions serially connected to the first sensing pads; and each second sensing series comprises a plurality of second sensing pads and a plurality of second connecting portions serially connected to the second sensing pads.

6. The touch display panel as claimed in claim 5, wherein the first dielectric layer is sandwiched between the first connecting portions and the corresponding second connecting portions.

7. The touch display panel as claimed in claim 5, wherein the first sensing pads are co-planar with the second sensing pads.

8. The touch display panel as claimed in claim 1, wherein the first operation area pattern comprises a plurality of first sensing pads, a plurality of second sensing pads and a plurality of first connecting portions, wherein the first sensing pads and the second sensing pads are arranged in a cross arrangement, and the first connecting portions are serially connected to the first sensing pads to constitute the first sensing series parallel to one another; and the second operation area pattern comprises a plurality of second connecting portions serially connected to the second sensing pads to constitute the second sensing series parallel to one another, wherein the dielectric layer is disposed between the first connecting portions and the second connecting portions.

9. The touch display panel as claimed in claim 1, wherein the first display area pattern is a first common electrode having a plurality of sub-openings, and the second display area pattern is a second common electrode having the openings, wherein the sub-openings are smaller than the openings and are exposed by the openings.

10. The touch display panel as claimed in claim 1, wherein the first display area pattern is a complete common electrode, and the second display area pattern comprises a plurality of pixel electrodes, wherein the pixel electrodes has openings for exposing the common electrode.

11. The touch display panel as claimed in claim 10, wherein the active array device comprises a plurality of active devices arranged in an array and electrically connected to the pixel electrodes.

12. The touch display panel as claimed in claim 11, further comprising a color filter layer disposed between the first display area pattern and the first substrate.
